(19) United States
(12) Patent Application Publication
(10) Pub. No.: US 2008/0307984 A1
(43) Pub. Date: Dec. 18, 2008

(54) DEBRIS COMPACTION DEVICE AND METHOD

(76) Inventor: Kenneth Brooks, Conley, GA (US)

Correspondence Address: GEORGE R. REARDON, 3356 STATION COURT, LAWRENCVILLE, GA, 30044, US

(21) Appl. No.: 11/762,335

(22) Filed: Jun. 13, 2007

(51) Int. Cl. B30B 9/00

(52) U.S. Cl. 100/227; 100/57

(57) ABSTRACT

A debris compaction device for use with compressing leaves within a leaf disposal bag is disclosed. One or more handles are provided on the top side of the debris compaction device to facilitate the compaction process. Air vents facilitate the channeling of air during the compaction process.

### FIELD OF THE INVENTION

The present invention relates generally to compaction devices, and more particularly to compaction devices for foliage.

### BACKGROUND OF THE INVENTION

Every autumn large quantities of foliage must be removed from municipal facilities, streets and other public and private areas. For a variety of reasons, foliage compaction is a high priority. Through higher compaction, foliage collection and the following transport or disposal would become more efficient and economical.

In the past leaves, cut grass and other yard materials have been collected and disposed of by raking and bagging these materials in bags. Generally the procedure consists of raking the material into a pile and then stuffing the piled leaves into bags either by hand or with the rake or both. The leaves, for example being light weight and somewhat resilient are not actually compacted using this method. A great deal of air is trapped between the leaves such that the amount of leaves in each bag is significantly less than what theoretically could be packed therein. This dictates that many bags must be used to pack a relatively small volume of leaves.

The bagging procedure is also slow since only a small quantity of leaves is insertable in the open trash bags at one time and the bag does not allow entrapped air to escape. Moreover, it is often the case that many leaves do not enter the bag because there may be too many for introduction or some leaves may become caught by the wind and blown away.

The present invention facilitates the compaction and containerization of leaves, grass and other compactable materials with significantly more speed, and less tedium than using the prior raking and bagging procedure and at appreciable materials savings. Material introduced within the container has the air displaced therefrom and in so doing the material is compacted so that the volume of accumulated material approaches its actual volume, and is thus more easily disposed of by the appropriate government entity.

Related art that addresses these and other problems includes the following patents.

U.S. Pat. No. 1,353,104, issued to Wetsler on Sep. 14, 1920, discloses a pickling weight of disk formation having a central opening therein, flat upper and lower faces, each provided with radial grooves extending from the central opening to the periphery of the weight, and hand holes between the central opening and the periphery.

U.S. Pat. No. D256,770, issued to Broyles on Sep. 9, 1980 illustrates a trash compactor.

U.S. Pat. No. 4,629,233, issued to Pfisterer on Dec. 16, 1986 discloses a device for compacting containerizing compactable material such as leaves, grass and trash. The device consists of a directing element having a front funnel section and a rear conduit, a rake and plunger element which is used to introduce material into the funnel section and force such material through the conduit; and a tubular netted bag having an open end mounted over the rear conduit. As material is pushed into the bag air is displaced ahead of and out the spaces in the netting material. The device can be assembled on legs to be used in an upright position and can be easily stored on a wall.

U.S. Pat. No. 4,991,500, issued to Knapp on Feb. 12, 1991, discloses a refuse compactor device having a container housing having an open top end for holding a trash bag in which the bag mouth is in registration with and folded over the open top end of the container for receiving trash to be compacted. The compactor device further includes a compactor plate received within the container housing for manual movement from the open top end of the housing toward the bottom end of the housing to compress refuse material in the trash bag. The housing has ventilation apertures in its side wall and bottom to allow air trapped between the bag and the side walls of the housing to be expelled from the container. The compactor plate also has ventilation apertures to allow air included in the refuse to be expelled from the container as the plate is moved into the trash bag and housing. The compactor plate further has an opening to receive therethrough the mouth end of the bag for convenient closing of the bag mouth.

U.S. Pat. No. 5,090,756, issued to Pfisterer on Feb. 25, 1992, discloses a device for compacting and containing compactable material, that includes a collapsible directing element having an entrance funnel section which converges into an exit section of smaller dimensions than said entrance funnel section, the funnel section including a hole therein; a clamp strap for clamping a netting material on the exit section; restraining straps for securing the clamp strap on the directing element, the restraining straps being connected between the directing element and the clamp strap; and an elongated cord for preventing movement of the directing element during a compacting operation, the elongated cord having a first end connected to the directing element at the hole and a second free end extending forwardly of the entrance funnel section and which can be engaged by a person for preventing movement of the directing element.

U.S. Pat. No. 5,857,408, issued to Witter on Jan. 12, 1999 discloses a compactor comprised of a body having a connector side and a compacting side. A lip extends from the compacting side. The lip forms and at least partially surrounds a cavity on the compacting side. Finally, a connector is provided on the connector side. A handle connects to the connector, and the cavity has a v-shape surface structure. The user grasps the handle and repeatedly lowers the compactor to compact the debris.

U.S. Pat. No. 5,862,748, issued to Witter on Jan. 26, 1999, discloses a manual refuse compactor.

While these patents and other previous methods have attempted to solve the problems that they addressed, none have utilized or disclosed an easy to use, economical debris compaction device, as does embodiments of the present invention.

Therefore, a need exists for a debris compaction device with these attributes and functionalities. The debris compaction device according to embodiments of the invention substantially departs from the conventional concepts and designs of the prior art. It can be appreciated that there exists a continuing need for a new and improved debris compaction device which can be used commercially. In this regard, the present invention substantially fulfills these objectives.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

In general, the invention features a device for the compaction of leaves. In a typical embodiment, a debris compaction apparatus is a leaf masher formed with one or more handles and shaped to fit within a leaf disposal bag.

In general, in one aspect, the invention features a substantially round disk having two handles for gripping and pressing in a downward movement to compress leaves that have been placed within a paper bag designed for the disposal of leaves.

In one implementation, the leaf masher has at least one air escape vent to channel air during the compaction process. Each air escape vent is preferably formed to have an entrance point at the bottom of the leaf masher and an exit point at the outside edge of the leaf masher, with an internal channel connecting the entrance point and the exit point. The shape of the entrance point, the exit point and the internal channel may be circular, oval, triangular, square, pentagon, hexagon, star, cross, etc. The entrance point, the exit point and the internal channel may all have the same shape or may be of different shapes. If more than one air escape vent is formed in the leaf masher, each air escape vent may utilize the same shapes, or may employ different shapes, e.g. sports mascots, letters, numbers, logos.

One advantage of the invention is that it compresses leaves within a bag designed for leaf disposal.

Another aspect of the present invention is that it may be made from readily available components.

Another aspect of the present invention is that it may be economically manufactured.

Another aspect of the present invention is that it may be made utilizing existing manufacturing techniques.

Other objects, advantages and capabilities of the invention are apparent from the following description taken in conjunction with the accompanying drawings showing the preferred embodiment of the invention.

### BRIEF DESCRIPTION OF THE SEVERAL VIEWS OF THE DRAWINGS

The invention, together with further advantages thereof, may best be understood by reference to the following description of the simplest form of the invention, taken in conjunction with the accompanying drawings in which:

FIG. 1 illustrates a debris compaction device inserted into a leaf refuse bag, according to an embodiment of the present invention.

FIG. 2 illustrates a debris compaction device inserted into a leaf refuse bag, further illustrating an air escape vent, according to an embodiment of the present invention.

FIG. 3 illustrates a top perspective view of a debris compaction device, further illustrating an air escape path, according to an embodiment of the present invention.

FIG. 4 illustrates a bottom perspective view of a debris compaction device, further illustrating entrance and egress points for air escape vents, according to an embodiment of the present invention.

FIG. 5 illustrates a side plan cross-sectional view of a debris compaction device, further illustrating air escape vents, according to an embodiment of the present invention.

FIG. 6 illustrates a top perspective view of a debris compaction device having two handles, according to an embodiment of the present invention.

FIG. 7 illustrates a top perspective view of a debris compaction device having a handle disposed on and within its circumference, according to an embodiment of the present invention.

### DETAILED DESCRIPTION OF THE INVENTION

The present invention will now be described in detail with reference to at least one preferred embodiment thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

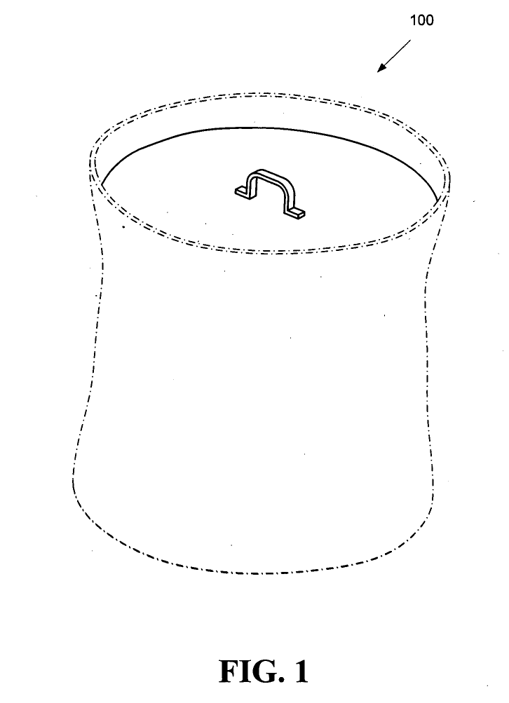

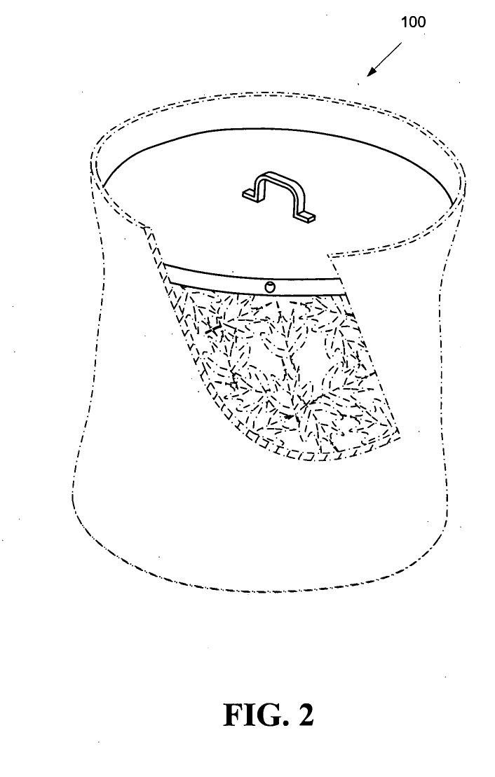

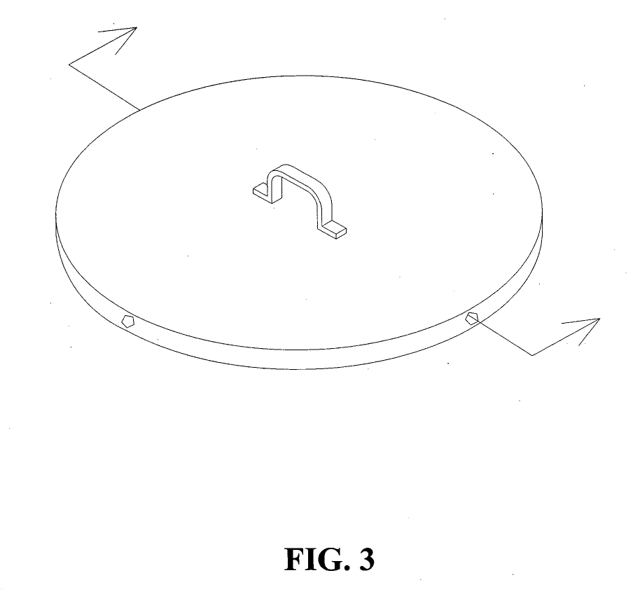

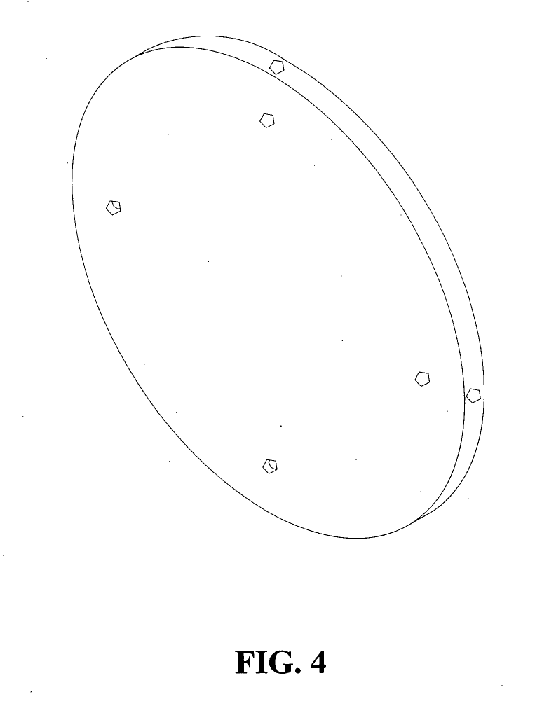

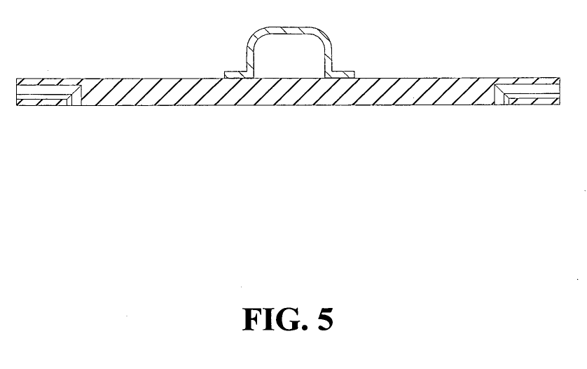

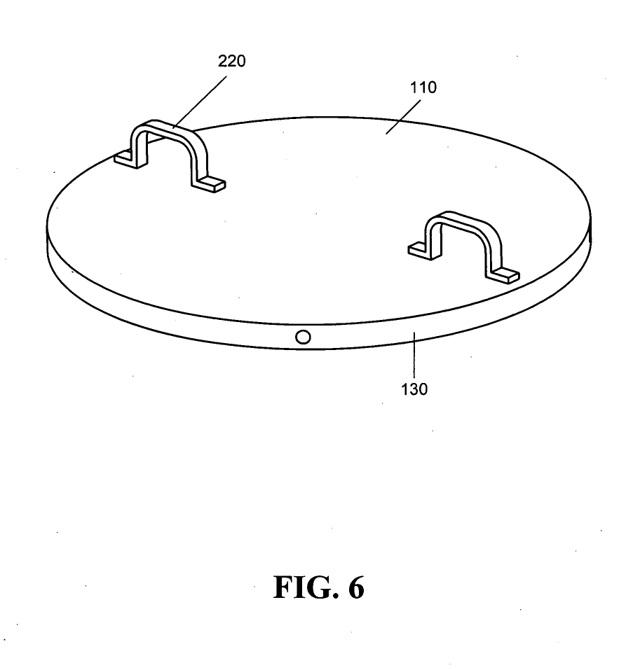

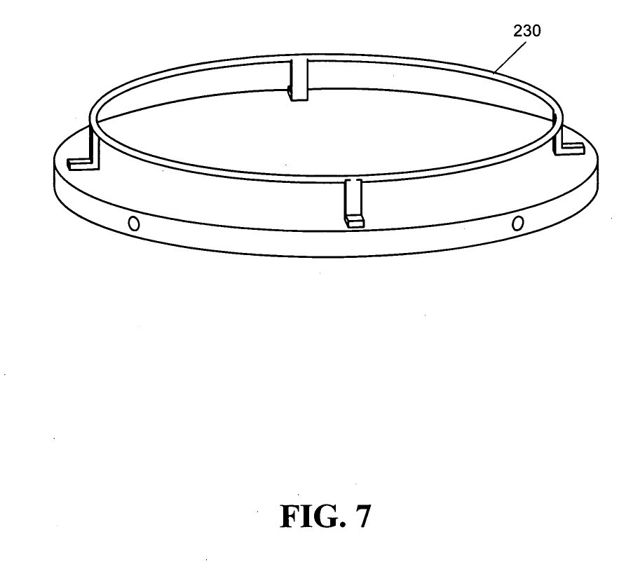

Referring to the drawings, FIGS. 1-7, wherein like reference numerals designate corresponding parts throughout the several figures, the following table lists the reference numerals:

| Reference Numeral | Description |
|---|---|
| 100 | Debris Compaction Device |
| 110 | Top |
| 120 | Bottom |
| 130 | Edge |
| 210 | Central Handle |
| 220 | Non-Central Handle |
| 230 | Annular Handle |
| 300 | Air Escape Vent |
| 310 | Bottom Port |
| 320 | Channel |
| 330 | Side Port |

A debris compaction device 100 has a top 110, a bottom 120 and an edge 130. The debris compaction device 100 further comprises at least one handle. The at least one handle may be a central handle 210, two or more of a non-central handle 220, an annular handle 230, or other handle shapes or arrangements. The at least one handle may be attached or affixed to the top 100. The at least one handle may be formed as an integral part of the debris compaction device 100 during the formation process, e.g. injection molding.

In an exemplary embodiment a debris compaction device 100 further comprises at least one air escape vent. The at least one air escape vent comprises a bottom port 310, a channel 320 and a side port 330. The bottom port 310 is disposed at the bottom 120, the side port 330 is disposed at the edge 130, and the channel 320 is formed to allow air to travel through the channel 320 from the bottom port 310 to the side port 330 when the debris compaction device 100 is compacting leaves. The at least one air escape vent is preferably a circular hole, but may be formed in different shapes

The foregoing description and drawings comprise illustrative embodiments of the present invention. Having thus described exemplary embodiments of the present invention, it should be noted by those skilled in the art that the within disclosures are exemplary only, and that various other alternatives, adaptations and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing description and the associated drawings. Although specific terms may be employed herein, they are used in a generic and descriptive sense only and not for purposes of limitation. Accordingly, the present invention is not limited to the specific embodiments illustrated herein, but is limited only by the following claims.

1. A debris compaction device for the compaction of leaves, cut grass and other yard materials made of a formable material and having a top side, a bottom side and an annular edge between the top side and bottom side, comprising:
a. a left handle and a right handle disposed on the top side;
b. a plurality of an air escape vent, wherein each air escape vent has an entrance port at the bottom side, an exit port at the annular edge and a channel connecting the entrance port to the exit port;
wherein the debris each air escape vent has a shape selected from the group consisting of circular, oval, triangular, square, pentagon, hexagon, star and cross.

2. The debris compaction device of claim 1, wherein the at least one handle is one central handle.

3. The debris compaction device of claim 2, further comprising at least one air escape vent.

4. The debris compaction device of claim 3, wherein the at least one air escape vent has an entrance port at the bottom side, an exit port at the annular edge and a channel connecting the entrance port to the exit port.

5. The debris compaction device of claim 4, wherein the at least one air escape vent has a circular shape.

6. The debris compaction device of claim 4, wherein the at least one air escape vent has a non-circular shape.

7-11. (canceled)

12. The debris compaction device of claim 1, wherein the at least one handle is an annular handle.

13. The debris compaction device of claim 12, further comprising at least one air escape vent.

14. The debris compaction device of claim 13, wherein the at least one air escape vent has an entrance port at the bottom side, an exit port at the annular edge and a channel connecting the entrance port to the exit port.

15. The debris compaction device of claim 14, wherein the at least one air escape vent has a circular shape.

16. The debris compaction device of claim 15, wherein the at least one air escape vent has a non-circular shape.

17. A debris compaction device for the compaction of leaves, cut grass and other yard materials made of a formable material and having a top side, a bottom side and an annular edge between the top side and bottom side, comprising:
a. a left handle and a right handle disposed on the top side;
b. a plurality of an air escape vent, wherein each air escape vent has an entrance port at the bottom side, an exit port at the annular edge and a channel connecting the entrance port to the exit port;
wherein each air escape vent has a shape selected from the group consisting of sports mascots, letters, numbers and logos.
